(19) United States
(12) Patent Application Publication
(10) Pub. No.: US 2021/0176923 A1
(43) Pub. Date: Jun. 17, 2021

(54) Organic Hemp Weed Barrier

(71) Applicant: Rachel Lanns, Prior Lake, MN (US)

(72) Inventor: Rachel Lanns, Prior Lake, MN (US)

(21) Appl. No.: 17/116,341

(22) Filed: Dec. 9, 2020

Related U.S. Application Data
(60) Provisional application No. 62/948,536, filed on Dec. 16, 2019.

(51) Int. Cl. A01G 13/02

(52) U.S. Cl. CPC A01G 13/0275; A01G 13/0293

(57) ABSTRACT

A weed barrier for limiting unwanted plant growth and method of making the same. The weed barrier comprises an inner layer of hemp burlap and a penetrating component. The penetrating component comprises a plurality of hemp fibers that are needle punched through the inner layer to form a top layer of the fibers and a bottom layer of the fibers. The inner layer is encapsulated between the inner and outer layers of fibers. A plurality of hemp spikes extend from the bottom of the weed barrier for engaging the soil to keep the weed barrier in place. The weed barrier is biodegradable and does not need to be removed after the growing season. For growing purposes, crop holes can be cut out anywhere in the weed barrier so the crop of choice can be grown and protrude outwardly there from. Additional layers and coatings of bioingredients and nutrients may also be added to the weed barrier.

### CROSS-REFERENCE TO RELATED APPLICATION

The present application claims priority to, and the benefit of, U.S. Provisional Application No. 62/948,536, which was filed on Dec. 16, 2019 and is incorporated herein by reference in its entirety.

### BACKGROUND

The present invention relates to agriculture industry in general, and specifically to an organic weed barrier. More specifically, the present invention relates to a multi-layer organic hemp weed barrier configured to prevent the growth of unwanted plant growth and helps with erosion control. However, it is to be appreciated that aspects of the present invention are also equally amenable to other like applications, devices and methods of manufacture.

Agriculture mainly depends on climatic condition, water resource, seeds and fertilizers. After a cultivation process, seeds of a desired plant are placed under the soil. However, weeds grow automatically by absorbing some amount of water and fertilizers. Weeds are undesirable plants that rapidly grow in farming fields, gardens, planters, and lawns. Preventing and controlling weed growth is crucial to healthy plant maintenance, and for aesthetic purposes. If not controlled, weeds can quickly overtake a lawn or garden, strangling desirable plants and blocking them from receiving crucial sunlight.

Many types of techniques and products exist for controlling and preventing weeds. Hand weeding is undoubtedly the oldest method of weed control. The weed uprooted by hand pulling or with a hoe dies from desiccation. However, hand weeding is expensive, and is not a pleasant task; it is tedious, dirty and involves long hot days in the field. It can sometimes be unfeasible for many gardeners and farmers. Mechanical methods using devices to pluck weeds or by hand plucking requires excess labor cost and are not convenient in many situations like in rainy days when soil is wet.

Homemade weed barriers typically include newspapers, plastic garbage bags, sheets of cardboard and other common household products. These conventional barriers are unsightly and evoke a disorganized, messy appearance. Strong winds may carry away loose sheets of newspapers or bags of plastic unless they're covered with a layer of topsoil or mulch defeating the purpose of the barrier.

Flame weeding is another alternative approach to weed management. Flame weeding includes passing a flame over a weed briefly to heat up the plant tissues just enough to kill them. Flame weeding kills the above ground portion of the weed, but it doesn't kill the roots. Further, a significant problem with flame weeding in gardens is that desired plants are exposed to the flame as well.

Vegetation of weeds is also controlled using chemicals such as herbicides. Herbicides sometimes kill or damage all the plants to which they are applied, i.e., both desired and undesired vegetation. Herbicides are also harmful for the farmers and gardeners who spray or apply them to the field and land as they contain harmful chemicals. Selective herbicides are effective at controlling and killing existing weeds, however, they do not prevent new ones from growing. Selective herbicides may also harm desirable, broadleaf, plants. Complete herbicides are extremely effective at killing anything green and temporarily prevent new weeds from growing. However, as the name suggests, complete herbicides will kill both weeds and desirable plants, thus, limiting their use. The chemicals in these herbicides are not only harmful to humans, but they contaminate the soil and crops as well.

A less harmful and sustainable way to stop weed growth is mulching. Mulch is a covering spread over the ground that conserves moisture in soil and suppresses the growth of weeds. In addition, mulch suppresses weed growth by preventing sun from reaching the soil. It further prevents rapid changes in soil temperature. Mulches provide various other advantages to a grower as well. It helps in preventing soil erosion and runoff from heavy rain. Moisture in the soil is conserved because of reduction in evaporation. In addition, mulch suppresses weed growth choking out the weeds by preventing sun from reaching the soil. A layer of mulch over soil also acts as an insulator by keeping the soil cool in the summer and helping to eliminate danger to plants from freeze-thaw cycles in the winter. While doing its task of keeping moisture in the soil and suppressing the growth of weeds, mulch also creates a rich unified background for plants, shrubs, and trees. When organic mulch decomposes, it becomes a valuable addition to the soil structure improving future crops.

Plastic or fabric mulching sheets or films are most often used to reduce weed growth. Unfortunately, these plastics and fabrics mulching sheets can release harmful chemicals into the soil and into the plants. Furthermore, millions of pounds of plastic agricultural waste are put into landfills each year. Produce marketed as organically grown is often grown using these tarps and fabrics, thereby negating the organic nature of the produce.

Various weed control methods are known in the art. However, their structure and advantages are substantially different from the present disclosure. Weed barriers may have surfaces designed to resist the elements including waxes and silicon, but do not provide the advantages of biodegradation. Not only does silicone contain heavy metals (Pt or Sn) coming from the cross-linked agent, it is not biodegradable because of its inert character. Therefore, there exists a long felt need in the art for biodegradable mulching sheets. More specifically, there is a long felt need in the art for biodegradable mulching sheets, which do not release harmful chemicals into the soil and into the plants, and do not contribute to agricultural waste.

The present invention, in one embodiment, provides for a barrier against unwanted plant growth. Further, the present invention reduces weeds, retains water, supports plant growth, and improves the soil during and after the growing season. The present invention has many advantages over other various weed control methods currently available in the marketplace including, without limitation, the following: (a) replaces the use of plastic mulching sheets and landscaping fabrics; (b) eliminates the release of harmful chemicals into the soil, produce, and environment; (c) creates healthier produce and improves agricultural practices; (d) eliminates the use of herbicides; (e) reduces waste added to landfills, thus reducing agricultural waste, and (f) helps with erosion control.

In this manner, the weed barrier of the present invention accomplishes all of the forgoing objectives, improving the ability of a user to successfully grow desired vegetation without the growth of surrounding weeds. The present invention provides an organic weed barrier for any end user in the agricultural industry, such as large to small farmers and growers, home gardeners, and landscaping companies. The weed barrier is configured to inhibit the growth of weeds and improve upon how produce is grown without the use of harmful chemicals by using a one hundred percent organic weed barrier.

### SUMMARY

The following simplified summary provides a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a barrier for limiting unwanted plant growth such as weeds. The barrier is used to protect crops from unwanted weed incursion. More specifically, the barrier comprises an inner layer and a penetrating component. The inner layer is a hemp burlap. The penetrating component comprises a plurality of hemp fibers. The plurality of hemp fibers penetrate the inner layer to form a top layer and a bottom layer of the hemp fibers that encapsulate the inner layer. The inner layer is at least 30 μm in thickness and either the inner, top, or bottom layer may be thicker than the others. Either the top or bottom layer may be positioned against the ground when in use. The barrier is organic and biodegradable.

The weed barrier further comprises a plurality of spikes. The plurality of spikes are typically biodegradable hemp spikes that extend from a bottom surface of the weed barrier. The bottom surface faces the ground and engages the soil. The plurality of spikes are configured to engage the ground surface to keep the weed barrier in place around the crops so that it does not blow away. The weed barrier may further comprise a plurality of openings. The plurality of openings are spaced apart and penetrate the inner, top, and bottom layers. The plurality of openings are configured to let a plant penetrate the weed barrier and grow from the soil.

The weed barrier may further be infused with a bioingredient coating. The bioingredient coating may cover either a top or the bottom surface of the weed barrier. The weed barrier may further be infused with a nutrient infusion. The nutrient infusion is configured to slowly release nutrients from either the first or second layer to the protected crops over a growing season. The weed barrier may further be infused with a carbonaceous material. The carbonaceous material layer may be infused in or coated on the top or bottom surface or may be sandwiched in between.

In an additional embodiment, a method of limiting weed growth using the weed barrier is illustrated. The method begins by obtaining a layer of hemp burlap. Next, a plurality of hemp fibers are needle punched through the inner layer of hemp burlap to encapsulate it with a top layer and a bottom layer of the hemp fibers. A plurality of holes are then cut into the weed barrier for receiving a crop. The weed barrier is then secured to the ground to protect the crop.

Further, the present invention provides those in the agricultural industry, such as commercial farmers and growers, home gardeners and landscaping companies with an organic hemp weed barrier to prevent the growth of weeds. The invention allows users to improve upon how produce is grown without the use of harmful chemicals by using a completely organic and biodegradable weed barrier. More specifically, the organic hemp weed barrier of present invention reduces weeds, retains water, supports plant growth, and improves the soil during and after the growing season. The organic hemp weed barrier of the present invention also replaces the use of plastic mulching sheets and landscaping fabrics, which can release harmful chemicals into the soil.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of one embodiment of a weed barrier of the present invention in accordance with the disclosed architecture.

FIG. 2 illustrates a perspective view of one embodiment of the weed barrier of the present invention where the weed barrier is in the form of a foldable roll in accordance with the disclosed architecture.

FIG. 3 illustrates a perspective view of an inner layer of the weed barrier of the present invention in accordance with the disclosed architecture.

FIG. 4 illustrates a side view of the weed barrier of the present invention in accordance with the disclosed architecture.

FIG. 5 illustrates a side view of a plurality of spikes of the weed barrier of the present invention in accordance with the disclosed architecture.

FIG. 6 illustrates a top view of one embodiment of the weed barrier of the present invention in an operable condition with crops growing without weeds in accordance with the disclosed architecture.

FIG. 7 illustrates a side perspective view of one embodiment of the weed barrier of the present invention in an operable position showing water permeation for optimum plant growth in accordance with the disclosed architecture.

FIG. 8 illustrates a flowchart of an exemplary method of limiting weed growth by forming and using a weed barrier of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

There exists in the art a long felt need for a weed barrier, which reduces unwanted weed growth for the optimum growth of the desired crops. There also exists in the art a long felt need for a biodegradable and organic weed barrier that is easily degradable, improves soil quality, and does not contribute to agricultural waste. There is also a need in the art for weed barriers, which retain moisture in the soil, ensure healthy production and eliminate the use of chemicals such as herbicides. There is also a long felt need in the art for weed barriers that maintains underground temperature and prevents loss of fertilizer components. The biodegradable and organic hemp weed barrier of the present invention satisfies all of the above needs and more. In differing embodiments of the present invention, the organic hemp weed barrier can be made into any size depending on its use.

The subject matter disclosed and claimed herein, in one embodiment thereof, comprises a barrier for unwanted plant growth. More specifically, the present invention relates to the field of weed controllers or weed barriers, which can be used especially in the field of agriculture, horticulture, industrial gardening and landscaping (such as tree nurseries, green spaces, etc.). Once the hemp weed barrier is placed on top of soil, rocks, metal spikes, or biodegradable hemp spikes are then used to hold the hemp weed barrier down. For growing purposes, at least one opening or hole can be located or cut out anywhere in the hemp weed barrier so a crop of choice can be grown, which may protrude outwardly there from. If the hemp weed barrier is for a one-time use like most growing operations, the hemp weed barrier can be left and or tilled into the soil at the end of the growing season. Further, the organic hemp weed barrier of the present invention may be available in various sizes to accommodate all user needs and preferences. Exact size, measurement, construction, and design specifications may vary upon further development and manufacturing. Aspects of the present invention provide an improved weed control method to be utilized by individuals belonging to the agricultural industry, large to small farmers and growers, home gardeners, and landscaping companies.

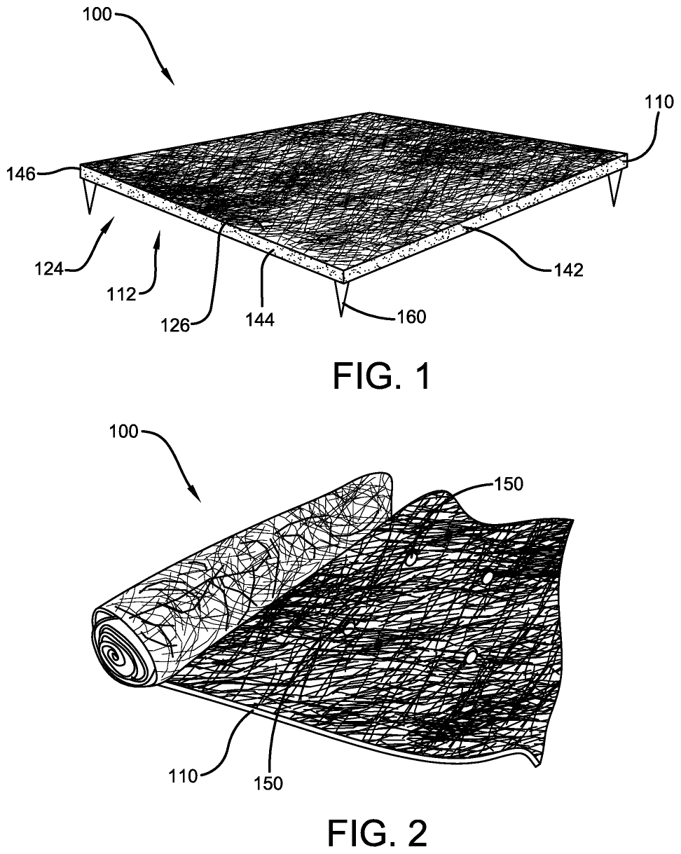

Referring initially to the drawings, FIGS. 1, 4 and 5 illustrate a barrier 100 for limiting unwanted plant growth such as weeds in accordance with the disclosed architecture. The weed barrier 100 is used to protect crops from unwanted weed incursion. The weed barrier 100 comprises an inner layer 110 and a penetrating component 120. The inner layer 110 is a hemp burlap. The penetrating component 120 comprises a plurality fibers 126. The plurality of fibers 126 are hemp fibers that are typically approximately up to two inches in length, although they may be longer or shorter as desired to meet GSM (grams per square meter) needs.

The plurality of hemp fibers 126 penetrate the inner layer 110 to form a top layer 122 and a bottom layer 124 of the hemp fibers that encapsulate the inner layer 110. When combined, inner layer 110 is sandwiched between the top layer 122 and the bottom layer 124 and integrated to form a heavy-duty barrier that inhibits weed growth. The plurality of hemp fibers 126 are typically needle punched through the inner layer 110. The inner layer 110 is typically approximately at least 30 μm in thickness and either the inner 110, top layer 122, or bottom layer 124 may be thicker than the others. Either the top layer 122 or bottom layer 124 may be positioned against the ground when in use. The weed barrier 100 is organic and biodegradable.

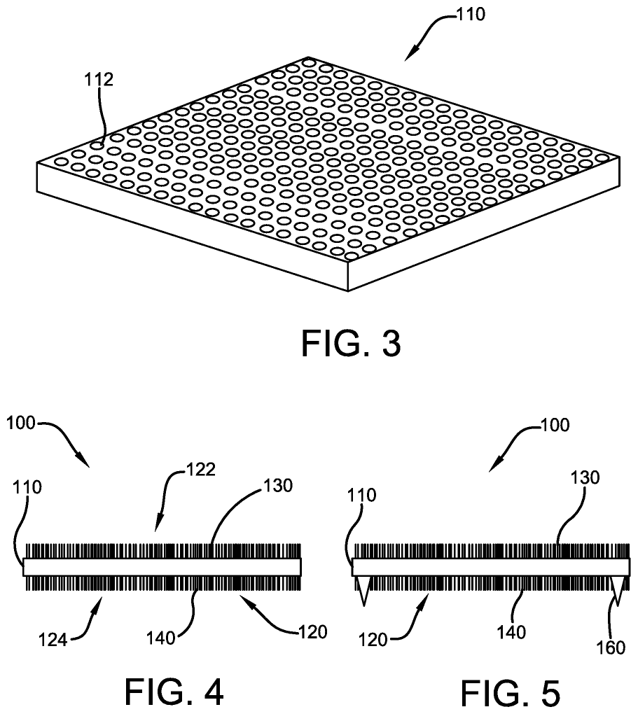

As illustrated in FIG. 3, the inner layer 110 may comprise a plurality of transmission apertures 112 that penetrate the inner layer 110. The plurality of transmission apertures 112 may be round, square, or of any geometric shape. The transmission apertures 112 enable water permeation through the weed barrier 100 and exhibit an excellent lowering effect of the underground temperature due to the promotion of the permeation of air through apertures 112 as illustrated in FIG. 7.

Hemp is an extremely durable fiber, which grows quickly. Woven and non-woven hemp fibers are also incredibly strong. Hemp plastic is a bio-plastic made using industrial hemp. There are many different types of hemp plastic such as standard plastics reinforced with hemp fibers, a 100% hemp plastic made entirely from the hemp plant, and the like. Hemp plastic is light-weight, recyclable and can be manufactured to be 100% biodegradable. Hemp plastic is considered to be five times stiffer and two-and-a-half times stronger than polypropylene plastics. Hemp fibers vary in length depending on ultimate use. The elongation property of hemp is 1 to 6%. Hemp also has the best ratio of heat capacity to all fibers giving it excellent insulation properties.

Referring to FIGS. 1, 4, and 5, the weed barrier 100 further comprises a top surface 130 and a bottom surface 140. The top surface 130 may be located on either the top layer 122 or the bottom layer 124. The top surface 130 faces the sky when installed on the ground. In an embodiment, the top surface 130 can be painted to enhance decorative appearance. For instance, in one embodiment the top surface 130 is painted with a trademark or logo of a particular company and/or farm. The bottom surface 140 similarly may be located on either the top layer 122 or the bottom layer 124. The bottom surface 140 faces the ground when installed. The weed barrier 100 further comprises a perimeter of a pair of length-wise edges 142, a pair of width-wise edges 144, and four corners 146. The weed barrier 100 of the present invention is typically rectangular in shape. However, the weed barrier 100 can be of any suitable shape including, without limitation, square, rhombic, circular, and triangular, with or without interlocking projections. When placed against the soil, the weed barrier 100 is particularly useful in limiting erosion.

Referring to FIGS. 1 and 5, the weed barrier 100 further comprises a plurality of spikes 160. The plurality of spikes 160 are typically biodegradable hemp spikes that extend from the bottom surface 140 of the weed barrier 100. The plurality of spikes 160 are configured to engage the ground surface anchoring the weed barrier 100 in place around the crops so that it does not blow away. The plurality of spikes 160 can be located adjacent to a perimeter of the weed barrier 100, symmetrically in all four corners 146 of the weed barrier 100 or asymmetrically scattered at any place in bottom surface 140. The length-wise edges 142 and the width-wise edges 144 of the weed barrier 100 can be either flat or with interlocking projections to fix more firmly with additional adjacent weed barrier sheets. The corners 146 of the weed barrier 100 can be pointed or curved in shape.

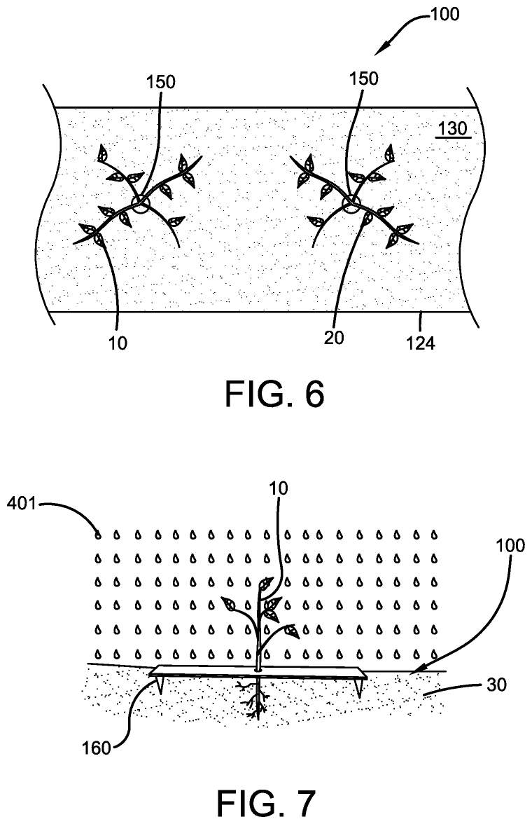

As illustrated in FIGS. 6 and 7, the weed barrier 100 may further comprise a plurality of openings 150. The plurality of openings 150 are spaced apart and penetrate the inner layer 110, the top layer 122, and the bottom layer 124. The plurality of openings 150 are configured to let a crop plant penetrate the weed barrier 100 and grow from the soil. The plurality of openings 150 are crop holes configured to let crop plants grow from the soil through the weed barrier 100. The weed barrier 100 may be manufactured with the plurality of openings 150 preformed, or the plurality of openings 150 may be later cut to customize a crop layout. The plurality of openings 150 may be separated at a suitable distance from one another. In one embodiment, the plurality of openings 150 are equidistant to each other. Further, the distance between the plurality of openings 150 is provided so that two crops can be at a distance suitable for growth of a plant. The spacing will depend on the type of plants that are planted and may vary accordingly.

As illustrated in FIG. 2, the weed barrier 100 may be configured as a foldable roll. However, the weed barrier 100 can be of any suitable form including, without limitation, sheets or flexible mats. The benefit of using a foldable roll configuration over a flat configuration is that it can be easily carried as a single unit and can be spread easily in the field without much manual effort, as it would be required in arranging separate flat weed barrier 100 one by one.

FIG. 6 illustrates the weed barrier 100 of the present invention in an operable condition with crops 10 and 20 growing without weeds in accordance with the disclosed architecture. A first crop 10 is positioned at a certain suitable distance from the second crop 20 for optimum growth and space for the crops 10 and 20. For instance, in one embodiment, the first crop 10 may be approximately twelve to eighteen inches apart from the second crop 20. The crops 10 and 20 pass through the plurality of openings 150. The plurality of openings 150 can be of any suitable size based on the type of crops 10 and 20 to be grown and can be of any suitable shape. Further, the weed barrier 100 can be utilized to protect various types of crops such as but not limited to carrot, onion, fennel, trees, ornamental or foliage plants and flowers, fruit- and vine-growing, lettuce, chicory and other leafy vegetables, corn, potato, and plants grown in nurseries etc. from unwanted weeds.

FIG. 7 illustrates the weed barrier 100 of the present invention in an operable position, showing water permeation for optimum growth of the crop 10. The weed barrier 100, unlike plastic mulching sheets, is permeable to water 401 and hence allows the crop 10 to receive more water 401 and facilitate healthier growth. The conventional plastic sheets are impermeable to water and do not let water underneath and creates an unhealthy plant. Also, since the weed barrier 100 of the present invention has optimum water permeation, it exhibits an excellent lowering effect of the underground temperature due to the promotion of the permeation of air through apertures. The weed barrier 100 is rendered resistant to weather, but remains permeable to water 401, and yet when buried in the soil 30, it eventually decomposes under the action of bacteriological forces. Alternatively, the weed barrier 100 can have micro-funnels that allow water and air to penetrate to the soil. Further, micro-funnel design allows air to constantly circulate to and from the soil 30, keeping it from souring or mildewing.

Further, the weed barrier 100 may be draped over the soil 30 of the field with the bottom surface 140 exposed and covering the top surfaces of the soil 30. There is a space between the weed barrier 100 and soil 30, which is closed when the dirt is pressed against the bottom surface 140. The edges of the weed barrier 100 may be pushed into the ground to anchor the weed barrier 100. The biodegradable hemp spikes 160 are also used to hold the weed barrier 100 down to the field. In one embodiment of the present invention a strip of spikes 160 can be also be used, on the length-wise 142 and width-wise edges 144 of the weed barrier 100.

In another embodiment, the weed barrier 100 can be made more functional using other bio-based ingredients with specific applications such as fertilizers, pollinators, insecticides and fungicides. The weed barrier 100 may further comprise a bioingredient coating or infusion. The bioingredient coating may cover or be infused within either the top or the bottom surface 130 and 140 of the weed barrier 100. The bioingredient coating may comprise a mixture of wood vinegar and peach leaves, which are eco-friendly materials with insecticidal or sterilizing properties and can be mixed and dispersed on or be infused within either the top or the bottom surface 130 and 140, in the manufacturing process of the weed barrier 100 to increase its strength and protect from various pests. Cinnamon powder can also be added to the weed barrier 100 to bring anti-bacterial properties. Sulfur, which has insecticidal activity can be added to the weed barrier 100. The bioingredients may also include; apple cider vinegar, neem oil, baking soda, chamomile tea, cinnamon as fungicides; white vinegar or apple cider vinegar as herbicides; and Epsom salt, eucalyptus oil, cinnamon oil, diatomaceous earth as natural pesticides; and honey as a pollinator.

In another embodiment of the present invention, different nutrients can be added to the composition of the weed barrier 100. The weed barrier 100 may further comprise a nutrient infusion to slowly release nutrients from the weed barrier 100 to the protected crops over a growing season. The plant nutrient substances can be selected from a wide group. As desired, the nutrients should be normally solid and/or water-soluble. Typical examples of nutrients that can be used are ammonium nitrate, ammonium sulfate, ammonium phosphate, potassium chloride, potassium nitrate, potassium sulfate, and urea. Mixtures of two or more such nutrients can, of course, be employed in forming the weed barrier 100 of this invention. The nutrients from the weed barrier 100 could be released at a sustainable rate and will help in proper growth of the desired crops 10 and 20.

In another preferred embodiment of the present invention, various adjuvant agents, including extenders, plasticizers, fillers, pigments, and the like, may be added to the weed barrier 100 manufacturing composition to modify and/or improve the qualities of the weed barrier 100. The weed barrier 100 may be further infused with a carbonaceous material. The carbonaceous material may cover or be infused within either the top or the bottom surface 130 and 140 of the weed barrier 100. The carbonaceous material is a material having a relatively high content of humid substances, for example at least one carbonaceous material from among the following: humus, soil, peat, cotton, or other fibers.

The weed barrier 100 can be completely decomposed to prevent environmental pollution. The weed barrier 100 may be converted to the manure component of the soil, as well as increase the firmness and soil adhesion of the weed barrier 100. At the end of the growing season, the weed barrier 100 is sufficiently snug against the field that it does not interfere with harvesting machinery. Typically, the weed barrier 100 will not break down over a single growing season so that the weed barrier 100 may be used over several growing seasons if desired. Hemp is naturally biodegradable, which means microorganisms can consume it. Not only does weed barrier 100 return to the soil as a natural source, but it adds humus to the soil. This process influences the bulk density of soil and contributes to moisture and nutrient retention. The pH neutral characteristics of hemp create a soil-rich base for future crops. When the weed barrier 100 is a single time use it can be tilled into the soil after harvesting of crops. The purpose of tilling is to mix organic matter present in weed barrier 100 into the soil.

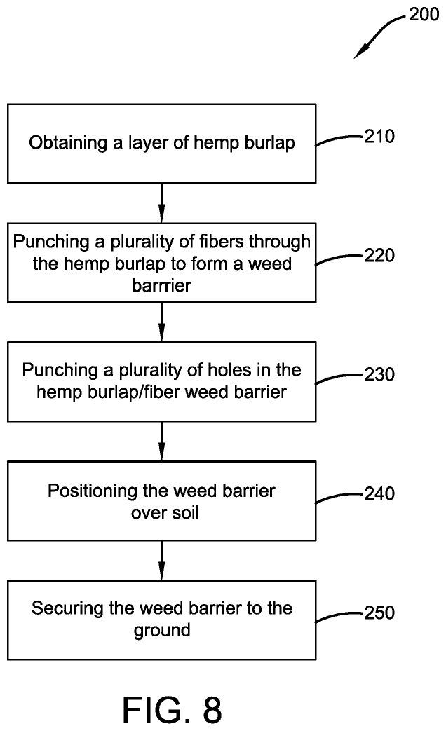

In an additional embodiment as illustrated in FIG. 8, a method 200 of limiting weed growth using the weed barrier is illustrated. The method 200 begins at 210 by obtaining a layer of hemp burlap 110. Next, a plurality of hemp fibers 126 are needle punched through the inner layer of hemp burlap 110 at 220 to encapsulate it with a top layer 122 and a bottom layer 124 of the hemp fibers 126. At 230, a plurality of holes 150 are then cut into the weed barrier 100 for receiving a crop 10. The weed barrier 100 is then positioned on the ground at 140 and then secured to the ground at 250 using the plurality of spikes 160 to protect the crop from weeds and the ground from erosion.

Throughout this specification the terms “weed controller”, “weed barrier”, “organic weed barrier” and “hemp weed barrier” maybe used interchangeably. Similarly, the alternative terms such as “film”, “layer”, “bed”, “sheet”, “mat” and “roll” can be used for “barrier”.

Notwithstanding the forgoing, the weed barrier 100 of the present invention and its various structural components can be of any suitable size, shape, and composition as is known in the art without affecting the overall concept of the invention, provided that it accomplishes the above stated objectives. One of ordinary skill in the art will appreciate that the shape and size of the weed barrier 100, as shown in the FIGS. are for illustrative purposes only, and that many other shapes and sizes of the weed barrier 100 are well within the scope of the present disclosure. Although the composition of the weed barrier 100 is important parameter for good crop growth, the weed barrier 100 and the plurality of openings 150 may be of any shape or size that ensures optimal crop growth during use and/or that suits user need and/or preference. Further, the distance between plurality of openings 150 may be varied as required for the particular vegetation being planted.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A barrier for limiting unwanted plant growth comprising:
an inner layer of hemp burlap; and
a penetrating component penetrating the inner layer forming a top layer and a bottom layer encapsulating the inner layer; and
wherein the barrier is biodegradable.

2. The barrier of claim 1, wherein the inner layer comprises a plurality of apertures penetrating the inner layer.

3. The barrier of claim 1, wherein the penetrating component comprises a plurality of fibers.

4. The barrier of claim 3, wherein the plurality of fibers are hemp fibers.

5. The barrier of claim 3, wherein each of the plurality of fibers are up to two inches in length.

6. The barrier of claim 1 further comprising a plurality of spikes extending from a bottom surface of the barrier.

7. The barrier of claim 6, wherein the plurality of spikes are biodegradable hemp spikes.

8. The barrier of claim 6, wherein the plurality of spikes are positioned adjacent to a perimeter of the barrier.

9. The barrier of claim 1, wherein the inner layer is thinner than the top layer and the bottom layer.

10. The barrier of claim 1, wherein the top layer and the bottom layer are both thicker than the inner layer.

11. A weed barrier for use in protecting crops comprising:
an inner layer of hemp burlap at least 30 μm in thickness;
a penetrating component penetrating the inner layer forming a top layer and a bottom layer encapsulating the inner layer;
a top surface;
a bottom surface; and
a plurality of spikes extending from the bottom surface.

12. The weed barrier of claim 11, wherein the penetrating component comprises a plurality of hemp fibers.

13. The weed barrier of claim 11, wherein the penetrating component is needle punched through the inner layer.

14. The weed barrier of claim 11, wherein the weed barrier is infused with a bioingredient coating.

15. The weed barrier of claim 14, wherein the bioingredient coating comprises a mixture of wood vinegar and peach leaves.

16. The weed barrier of claim 11, wherein the weed barrier is infused with a nutrient infusion.

17. The weed barrier of claim 16, wherein the nutrient infusion is an infusion of at least one of ammonium nitrate, ammonium sulfate, ammonium phosphate, potassium chloride, potassium nitrate, potassium sulfate, or urea.

18. The weed barrier of claim 11, wherein the weed barrier is configured as a flexible mat.

19. The weed barrier of claim 11, wherein the weed barrier is infused with a carbonaceous material.

20. A method of limiting weed growth using a weed barrier comprising:
obtaining a layer of hemp burlap;
needle punching a plurality of hemp fibers through the layer of hemp burlap to form the weed barrier;
cutting a plurality of holes in the weed barrier;
securing the weed barrier to the ground to protect a crop from weeds and the ground from erosion.
